(19) United States
(12) Patent Application Publication
(10) Pub. No.: US 2014/0089467 A1
(43) Pub. Date: Mar. 27, 2014

(54) CONTENT STREAM DELIVERY USING PRE-LOADED SEGMENTS

(71) Applicants: Andre Beck, Batavia, IL (US); Jairo O. Esteban, Freehold, NJ (US); Steven A. Benno, Towaco, NJ (US); Volker F. Hilt, Middletown, NJ (US); Ivica Rimac, Remseck (DE); David S. Ferguson, Cambridge (GB)

(72) Inventors: Andre Beck, Batavia, IL (US); Jairo O. Esteban, Freehold, NJ (US); Steven A. Benno, Towaco, NJ (US); Volker F. Hilt, Middletown, NJ (US); Ivica Rimac, Remseck (DE); David S. Ferguson, Cambridge (GB)

(21) Appl. No.: 13/628,522

(22) Filed: Sep. 27, 2012

(51) Int. Cl. H04L 29/08

(52) U.S. Cl. CPC H04L 67/02
USPC 709/219

(57) ABSTRACT

A method comprises receiving a first request for a first segment of a content stream in a network element from a given one of a plurality of clients, determining in the network element whether the first segment is stored in a memory of the network element, sending a second request for the first segment from the network element to a server responsive to the determining step, receiving a response comprising the first segment in the network element from the server responsive to the second request, and sending the first segment from the network element to the given one of the plurality of clients. The first segment is related to a second segment of the content stream, the relationship being transparent to the network element but being inferable based at least in part on at least one of the first request, the response and one or more prior requests.

### RELATED APPLICATION

The present application is related to the patent application identified by Attorney Docket No. 809960-US-NP, titled “Content Stream Delivery Using Variable Cache Replacement Granularity,” filed concurrently herewith, the disclosure of which is incorporated by reference herein.

### FIELD

The field relates generally to content delivery and, more particularly, to techniques for streaming content.

### BACKGROUND

Today, there is a growing demand for content delivery over various networks and network types. End users or content consumers may desire access to various types of content, including video and audio streams. The bandwidth available to the end users, however, may vary greatly depending on a geographical location of a particular end user, network connection type, network load, etc. As such, content streams such as video and audio streams are often available in a number of quality levels. End users can manually choose to receive a given content stream in a specific quality level, or may choose to let the specific quality level be determined based on current network characteristics or bandwidth allotment.

Typically, end users will request content at the best available quality level based on the current network characteristics. The network characteristics for a given end user, however, may vary greatly during delivery of the content stream. For example, an end user may initially have a large amount of bandwidth available and select a high quality level for a content stream. Seconds or minutes later however, the bandwidth available may be significantly lower, and thus the high quality content stream may be interrupted for buffering during delivery of the content stream. To solve this problem, adaptive streaming techniques have been developed which allow for delivery of a content stream in a plurality of quality levels. As network characteristics change during delivery of the content stream, the quality level delivered to an end user will change dynamically to ensure smooth and uninterrupted delivery of the content stream.

Hypertext Transfer Protocol (HTTP) Adaptive Streaming (HAS) is one such adaptive streaming technique. HAS solutions can encode a given content stream such as a video stream in several different quality levels. Each quality level is split into small chunks or segments. Each chunk or segment is typically a few seconds in length. Corresponding audio streams may also be divided into separate chunks.

### SUMMARY

Embodiments of the invention provide techniques for streaming content in a network.

For example, in one embodiment, a method comprises the steps of receiving a first request for a first segment of a content stream in a network element from a given one of a plurality of clients, determining in the network element whether the first segment is stored in a memory of the network element, sending a second request for the first segment from the network element to a server responsive to the determining step, receiving a response comprising the first segment in the network element from the server responsive to the second request, and sending the first segment from the network element to the given one of the plurality of clients. The first segment is related to a second segment of the content stream, the relationship between the first segment and the second segment being transparent to the network element but being inferable based at least in part on at least one of the first request, the response and one or more prior requests.

In another embodiment, a network element comprises a memory and a processor coupled to the memory. The processor is operative to receive a first request for a first segment of a content stream from a given one of a plurality of clients, determine whether the first segment is stored in the memory, send a second request for the first segment to a server responsive to the determination, receive a response comprising the first segment from the server responsive to the second request, and send the first segment to the given one of the plurality of clients. The first segment is related to a second segment of the content stream, the relationship between the first segment and the second segment being transparent to the network element but being inferable based at least in part on at least one of the first request, the response and one or more prior requests.

In another embodiment, a system comprises a plurality of clients, at least one network element comprising a memory and at least one server. A given one of the plurality of clients is configured to send a first request for a first segment of a content stream to the at least one network element and receive the first segment from the at least one network element. The at least one network element is configured to receive the first request, determine if the first segment is stored in the memory, send a second request for the first segment to the at least one server responsive to the determination, receive a response comprising the first segment from the at least one server responsive to the second request, and send the first segment to the given one of the plurality of clients. The at least one server is configured to receive the second request from the at least one network element and send the first segment to the at least one network element. The first segment is related to a second segment of the content stream, the relationship between the first segment and the second segment being transparent to the network element but being inferable based at least in part on at least one of the first request, the response and one or more prior requests.

Advantageously, illustrative embodiments of the invention allow for efficient storage and caching in content streaming systems.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates a streaming content system, according to an embodiment of the invention.

FIG. 2 illustrates a methodology for streaming content, according to an embodiment of the invention.

FIG. 3 illustrates another methodology for streaming content, according to an embodiment of the invention.

FIG. 4 illustrates a processing architecture used to implement a streaming content system, according to an embodiment of the invention.

### DETAILED DESCRIPTION

Embodiments of the invention will be described below in the context of illustrative apparatus, methods and systems. However, it is to be understood that embodiments of the invention are not limited to the specific apparatus, methods and systems described herein, but are more generally applicable to any apparatus, methods and systems wherein it is desirable to improve content streaming.

Embodiments of the invention are described below in the context of HAS systems. It is important to note, however, that embodiments of the invention are not limited solely to use in HAS systems, but instead are more generally applicable to various content streaming systems.

The terms “segment” and “chunk” as used herein refer to independent objects of a content stream. These terms are used interchangeably herein, and are intended to be construed broadly. The term “portion” as used herein refers to a group of independent objects of a content stream. In addition, while various embodiments may be described below referring to a caching proxy, embodiments of the invention are not limited solely to use with caching proxies. Instead, any suitable network element or elements, such as content distribution nodes, surrogate nodes, servers, etc. may be used.

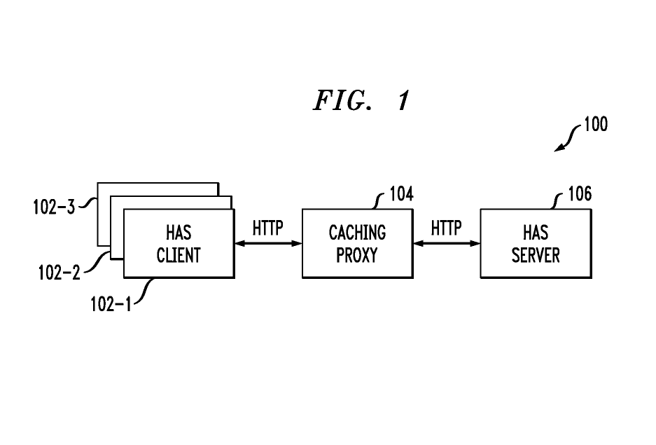

FIG. 1 shows an example of a content streaming system 100. A plurality of HAS clients 102-1, 102-2 and 102-3 interact with a caching proxy 104, which in turn interacts with an HAS server 106. In the content streaming system 100, the HAS clients 102-1, 102-2 and 102-3, the caching proxy 104 and the system 106 interact by exchanging HTTP commands. It is to be understood, however, that embodiments of the invention are not limited solely to the system 100 shown in FIG. 1. For example, the number of HAS clients 102 may vary. In addition, HAS clients may interact with more than one caching proxy. In some embodiments, the HAS clients do not interact with a caching proxy, but may instead interact with other network elements which interact with content servers. A given caching proxy may also be configured to interact with a number of HAS servers. In other embodiments, each HAS server may have one or more associated caching proxies or network elements which interact with HAS clients or other end users. One skilled in the art will readily appreciate that various other arrangements are possible.

In HAS solutions, each content chunk or segment is an individual and self-contained HTTP object, and thus the inter-relation of chunks is application context transparent to intermediary nodes such as caching proxies. In addition, the caching proxy is unable to anticipate changes in the requested quality level of subsequent chunks in a content stream. Thus, a caching proxy cannot make use of performance optimization techniques. For example, caching proxies are unable to pre-fetch chunks from a content server, a neighboring cache, or disk storage to ensure that subsequent chunk requests are served efficiently from the cache. This in turn may result in cache misses which can cause an HAS client to select a lower video quality level. If cache hits are frequently followed by cache misses, the HAS client may begin to oscillate between different quality levels which will negatively affect the quality for the end user. In addition, it is typically impractical to store an entire HAS content stream in a fast memory of a caching proxy, as HAS content streams available in a plurality of quality levels require significantly more storage than a traditional content stream available in only a single quality level.

Embodiments of the invention overcome the above-noted drawbacks of existing HAS solutions by providing techniques for inferring subsequent chunks in a content stream based at least in part on currently requested chunks of the content stream. In some embodiments, HAS clients 102-1, 102-2 and 102-3 and/or HAS server 106 signal to caching proxy 104 which chunk or chunks that a given HAS client is most likely to request next via a hint or some other indication based on the currently request chunk. The caching proxy 104 can use this information to pro-actively fetch the next chunk from the HAS server 106 or a neighboring cache while it is serving a currently requested chunk to the given HAS client. If the caching proxy 104 already has the next chunk cached, the caching proxy may optimize its memory or resource management accordingly. For example, if the caching proxy 104 has first-level and second-level memory, the caching proxy 104 may pre-load the next chunk from the slower first-level to the faster second-level memory. The first-level memory may be a disk storage memory such as a hard drive, while the second-level memory may be a flash memory. Pre-loading the next chunk can reduce disk seek times and thus improve performance of the system. If the caching proxy 104 receives hints from multiple clients in parallel, the caching proxy 104 may use policies to determine how to prioritize pre-fetching or pre-loading of chunks in order to optimize memory and resource management.

Several techniques may be used to signal the hint or indication of the next chunk or group of chunks to the caching proxy 104. In some embodiments, a given HAS client 102-1 can embed the hint or indication of which chunk it intends to request next either as an additional HTTP GET parameter or as a custom HTTP request header in the request for the current chunk. The given HAS client 102-1 may use data from its rate determination algorithm to assess which chunk it is likely to request next (i.e., higher quality level, lower quality level or the same quality level as the currently requested chunk). The given HAS client 102-1, however, is not obligated to actually request the next chunk signaled to the caching proxy 104. For example, if the given HAS client 102-1 experiences a sudden drop or increase in download bandwidth, the next requested chunk may differ from the likely next chunk which was signaled to the caching proxy 104. The given HAS client 102-1 may also omit a hint or indication of the next chunk if the HAS client 102-1 is unable or unsure how to determine a likely next chunk which will be requested. The caching proxy 104 parses the HTTP request header or HTTP GET parameter to pre-fetch the next chunk if it is not already cached.

In other embodiments, the HAS server 106 may embed the hint or indication to the caching proxy 104 in an HTTP response to a chunk request as a custom HTTP header. The HAS server 106 may use statistics collected from other HAS clients such as HAS clients 102-2 and 102-3 as well as the HAS server 106's knowledge of the HAS manifest file to predict which chunk the given HAS client 102-1 is likely to request next. The HAS server 106 may use the HTTP ‘Link’ header that is currently being standardized by the Internet Engineering Task Force (IETF) to signal which chunk the given HAS client 102-1 is likely to request next. In some embodiments, the caching proxy 104 may similarly use statistics to determine a chunk which is likely to be requested next.

In other embodiments, both the given HAS client 102-1 and the HAS server 106 may provide a list of prioritized or scored chunk URLs to indicate the request probability of each listed chunk. The scores may be calculated based on static factors and dynamic factors. One example of such a static factor is that the given HAS client 102-1 is most likely to want the same chunk bit rate or quality level, and is less likely to want chunks at bit rates or quality levels further away from the currently requested chunk bit rate or quality level. Dynamic factors may include the given HAS client 102-1's view of the rate of change in a buffer, or by the HAS server 106's view of past requests or other activity. One skilled in the art will readily appreciate that various other factors may be used, which take into account the status of and network characteristics between the given HAS client 102-1, the caching proxy 104 and the HAS server 106.

In some embodiments, the caching proxy 104 may retrieve the manifest file associated with the HAS content stream so that the caching proxy 104 knows how to request the client-announced chunks from the HAS server 106 or from a neighboring cache. Alternatively, this information (e.g., a URL) may be embedded in the hint which is signaled to the caching proxy 104.

In a given content stream, chunks or segments of the content stream are related to one another. The caching proxy 104 or other network element which receives requests from clients for chunks or segments of the given content stream, however, is not aware of the relationship between a requested chunk or segment and the next chunk or segment which may be requested. As such, the relationship between chunks or segments of the content stream is transparent to the network element or caching proxy. Embodiments of the invention use the techniques described above and to be described below to infer the relationship between a requested chunk or segment and one or more next chunks or segments which may be requested.

It should be appreciated that the various techniques described above to signal the hint or indication of the next chunk to the caching proxy 104 may combined in one or more embodiments. For example, some embodiments may use all of or some subset of the techniques described above to signal the hints or indications of the next chunk. In addition, while embodiments have been described above with respect to content streams in HAS solutions, the invention is not limited solely to use with content streams in HAS systems. Instead, embodiments and techniques as described above may be used for various other types of content.

For example, web pages typically consist of multiple web objects such as images, style sheets, JavaScript files, etc. After parsing the Hypertext Markup Language (HTML) code of a web page, a web browser knows which web objects it needs to retrieve to render the page. When the web browser requests one of the embedded objects, a hint or other indication of web objects which are likely to be requested next may be signaled to a caching proxy or network element as described above. As described above, a caching proxy or network element which receives the hint or indication may pre-load the likely web objects from an origin server containing the content, a neighboring cache or network element which stores the content, or may move the likely web objects from a slower type of memory to a faster type of memory in the caching proxy or network element. As a particular example, online map web pages typically consist of multiple image tiles which are retrieved to render the page. Thus, the web browser can include a custom header listing the URLs of some or all of the subsequent image tiles used to render the page in the HTTP GET request the web browser sends for the first image tile.

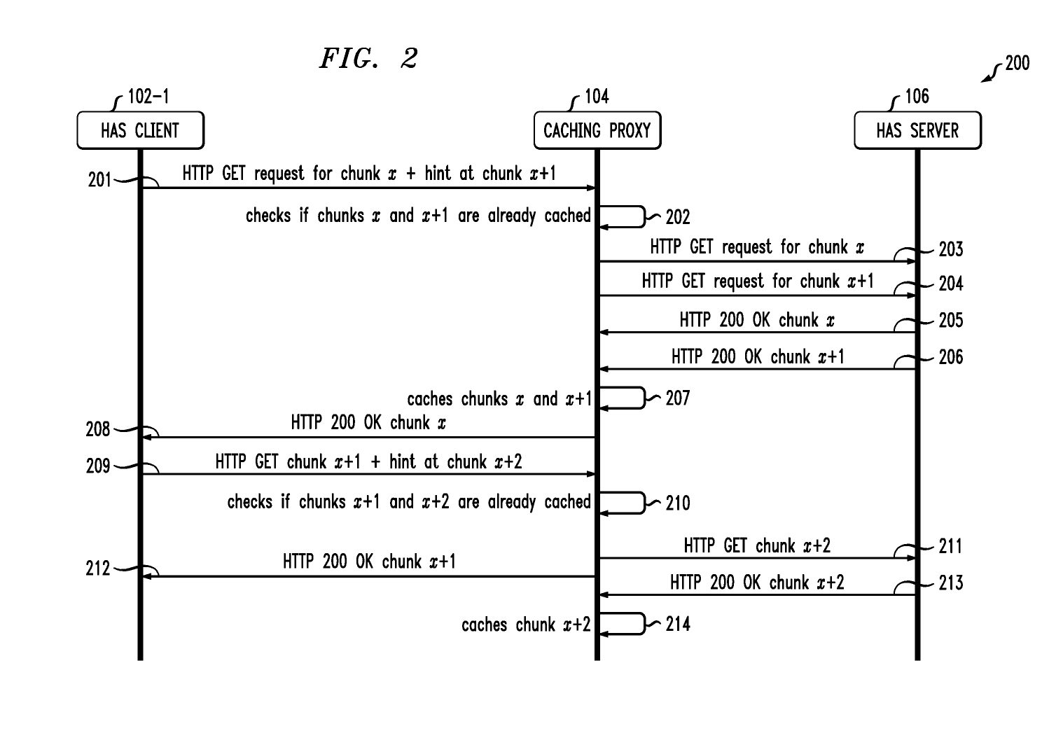

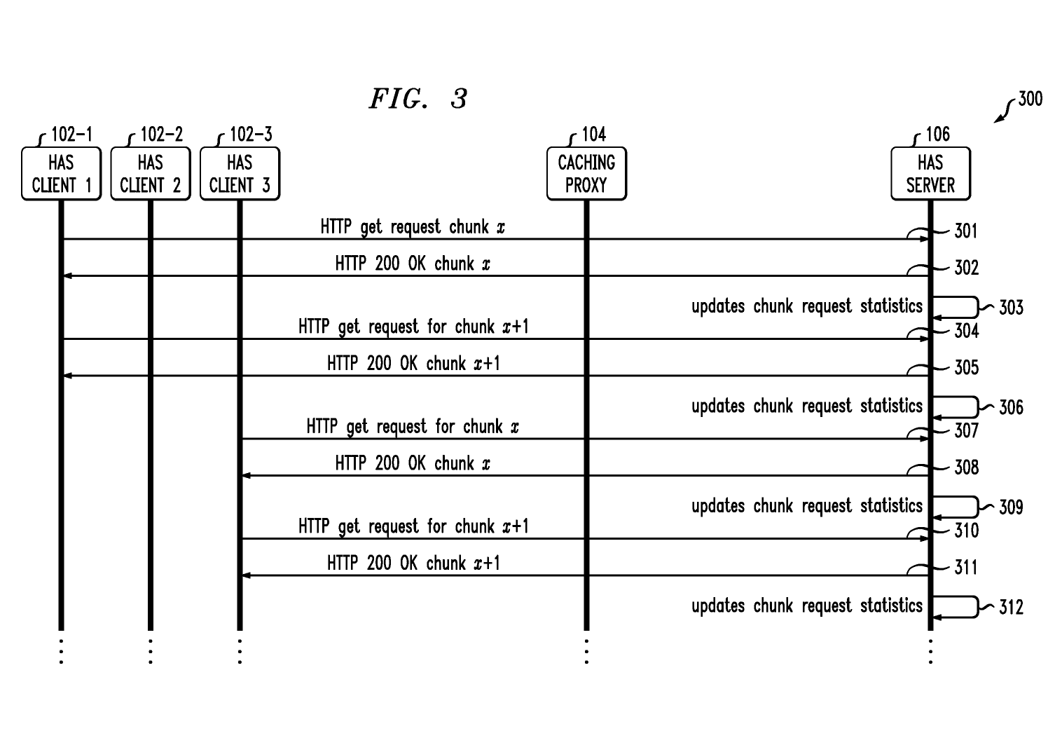

FIG. 2 illustrates a methodology 200 for streaming content. A given content stream X may be divided into a number of chunks (i.e., x, x+1, x+2, . . . , x+IV) for each of a plurality of quality levels. The methodology 200 begins with HAS client 102-1 sending 201 an HTTP GET request for a chunk x. The HTTP GET request for chunk x includes a hint at the next chunk x+1 which will likely be requested. In some embodiments, the hint can indicate the next N chunks which are likely to be requested. For example, the hint may include an indication of chunk x+1, chunk x+2, chunk x+N. In addition, the hint may include an indication of a quality level of chunk x+1, or a list of quality levels and respective probabilities for each of the quality levels of chunk x+1 which are likely to be requested next. In response to the HTTP GET request, the caching proxy 104 checks 202 if chunks x and x+1 are already cached or otherwise stored in the caching proxy 104. As described above, if chunk x+1 is stored in a slower memory of the caching proxy 104, the caching proxy 104 may move chunk x+1 to a faster memory in response to the HTTP GET request.

If the caching proxy 104 does not have chunk x cached or otherwise stored, the caching proxy 104 sends 203 and HTTP GET request for chunk x to the HAS server 106. Similarly, if the caching proxy 104 does not have chunk x+1 cached or otherwise stored, the caching proxy 104 sends 204 an HTTP GET request for chunk x+1 to the HAS server 106. In some embodiments, the caching proxy 104 will also check to see whether chunk x and chunk x+1 are stored in a neighboring cache or network element before performing steps 203 and 204. The HAS server 106 sends 205 an HTTP 200 OK message including chunk x to the caching proxy 104 responsive to the HTTP GET request for chunk x. The HAS server 106 similarly sends 206 an HTTP 200 OK message including chunk x+1 to caching proxy 104. In response to the HTTP 200 OK messages, the caching proxy 104 caches 207 chunks x and x+1. The caching proxy 104 then sends 208 an HTTP 200 OK message with chunk x to HAS client 102-1.

The HAS client 102-1 may subsequently send 209 an HTTP GET request for chunk×+1 which includes a hint at chunk x+2. It is important to note, however, that the HAS client 102-1 is not obligated to request chunk x+1 after requesting chunk x. As described above, the HAS client 102-1 may request a different chunk due to changing network characteristics and other static and dynamic factors. In addition, the HAS client 102-1 may choose to stop requesting the content stream. In response to step 209, the caching proxy 104 check if chunk x+1 and chunk x+2 are already cached. The caching proxy 104 sends 211 an HTTP GET request for chunk x+2 to HAS server 106, and sends 212 an HTTP OK 200 message including chunk x+1 to HAS client 102-1. Advantageously, chunk x+1 is already cached in the caching proxy 104 in step 207 responsive to the request sent in step 201. It is important to note however, the in step 210 the caching proxy 104 still checks to determine if chunk x+1 is cached to account for situations in which there may be some delay between requests from HAS client 102-1. For example, HAS client 102-1 may choose to pause the content stream and resume sometime later. The caching proxy 104 may discard chunk x+1 from the cache after a certain time to account for this and other situations.

In response to step 211, the HAS server 106 sends 213 an HTTP 200 OK message including chunk x+2 to the caching proxy 104. The caching proxy 104 then caches 214 chunk x+2. The methodology 200 may be repeated for subsequent chunks x+3, x+4, etc. as required. It is also important to note that while methodology 200 shows only a single HAS client 102-1, embodiments are not limited solely to this arrangement. Instead, the methodology 200 may be used for a plurality of HAS clients.

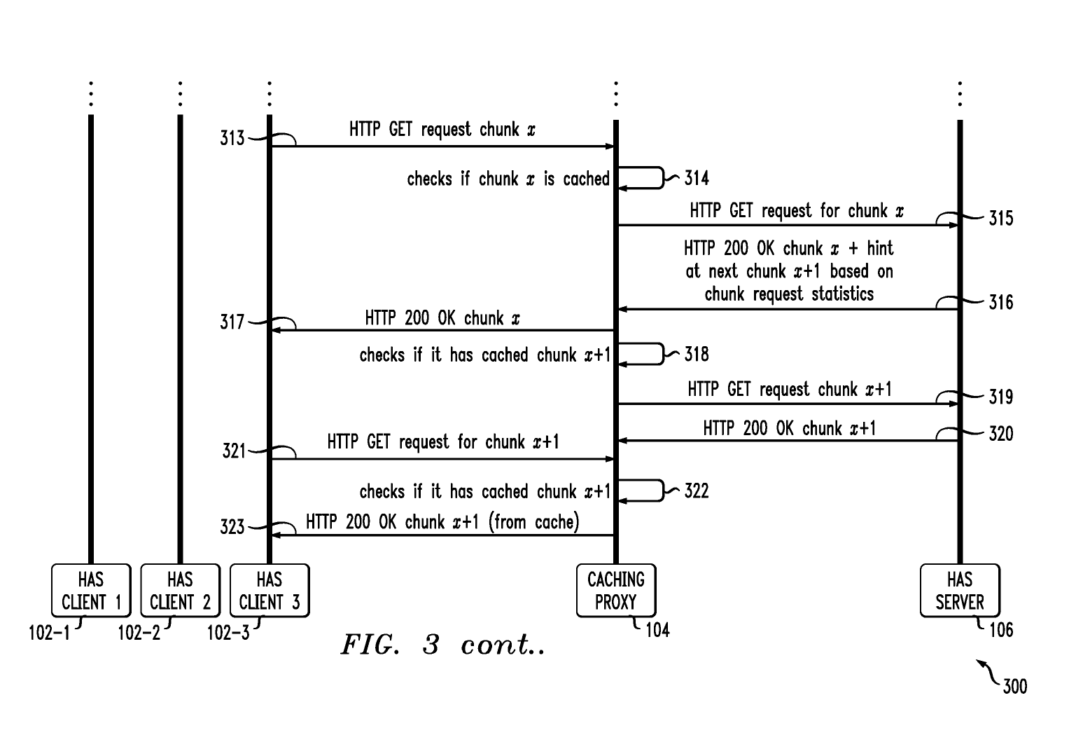

FIG. 3 illustrates another methodology 300 for streaming content. A given content stream X may be divided into a number of chunks (i.e., x, x+1, x+2, . . . , x+N) for each of a plurality of quality levels. In step 301, HAS client 102-1 sends an HTTP GET request for chunk x to HAS server 106. In response, the HAS server 106 sends 302 an HTTP OK message including chunk x to HAS client 102-1. The HAS server 106 then updates 303 chunk request statistics. The HAS server can maintain chunk request statistics for various content streams. In step 304, HAS client 102-1 sends an HTTP GET request for chunk x+1 to HAS server 106. In response, HAS server sends 305 an HTTP 200 OK message including chunk x+1 to HAS client 102-1. The HAS server 106 then updates 306 the chunk request statistics.

In step 307, HAS client 102-2 sends an HTTP GET request for chunk x to HAS server 106. In response, the HAS server 106 sends 308 an HTTP 200 OK message including chunk x to HAS client 102-2. The HAS server then updates 309 the chunk request statistics. In step 311, the HAS client 102-2 sends an HTTP GET request for chunk x+1 to HAS server 106. In response, the HAS server 106 sends 311 an HTTP 200 OK message include chunk x+1 to HAS client 102-2. The HAS server then updates 312 the chunk request statistics.

In step 313, HAS client 102-3 sends an HTTP GET request for chunk x to caching proxy 104. Caching proxy 104 then checks 314 if chunk x is cached. If chunk x is not cached, caching proxy 104 sends an HTTP GET request for chunk x to HAS server 106. In response, the HAS server 106 sends 316 an HTTP 200 OK message including chunk x and a hint at the next chunk x+1 based on the chunk request statistics to the caching proxy 104. The caching proxy 104 then sends 317 an HTTP 200 OK message including chunk x to HAS client 102-3. The caching proxy next checks 318 if chunk x+1 is cached. If chunk x+1 is not cached, caching proxy 104 sends 319 an HTTP GET request for chunk x+1 to HAS server 106. In response, the HAS server 106 sends 320 an HTTP 200 OK message including chunk x+1 to caching proxy 104.

In step 321, HAS client 102-3 sends an HTTP GET request for chunk x+1 to caching proxy 104. Caching proxy 104 checks 322 if chunk x+1 is cached. Caching proxy 104 then sends 323 HTTP 200 OK message including chunk x+1 to the HAS client 102-3. Advantageously, chunk x+1 is pre-fetched by the caching proxy 104 prior to step 321, thus improving caching efficiency.

It is important to note that the methodology 300 is merely one example in which the hint at a next chunk x+1 is determined based on chunk request statistics. For example, the HTTP GET requests sent in steps 301, 304, 307 and 310 may alternately be sent to caching proxy 104 rather than HAS server 106. In some embodiments, the caching proxy 104 may thus update and maintain chunk request statistics locally. In other embodiments, the HAS server 106 may still update chunk request statistics based on requests received from the caching proxy 104 when the caching proxy 104 does not have the requested chunks cached. For example, in the methodology 200 of FIG. 2, the HAS server 106 may update chunk request statistics in response to the HTTP GET requests of steps 203, 204 and 211. In other embodiments, both the caching proxy 104 and the HAS server 106 may maintain and update chunk request statistics. In addition, the methodology 300 may also be used to determine a next N number of likely chunks which will be requested. For example, in step 316, the HAS server 106 may include the hint for chunk x+1 and chunks x+2, x+x+N. The hint may also include a list of chunks x+1 at various quality levels, including a probability that the chunk x+1 will be requested for each of the various quality levels based on the chunk request statistics.

It is important to note that while methodologies 200 and 300 are discussed separately, these methodologies may be combined in one or more embodiments of the invention. In addition, while various steps in methodologies 200 and 300 are described in a sequential order, some of these steps may be performed in a different order or in parallel. By way of example only, steps 302 and 303 in methodology 300 may be performed in parallel or in reverse order. Numerous other examples are possible, as will be appreciated by one skilled in the art.

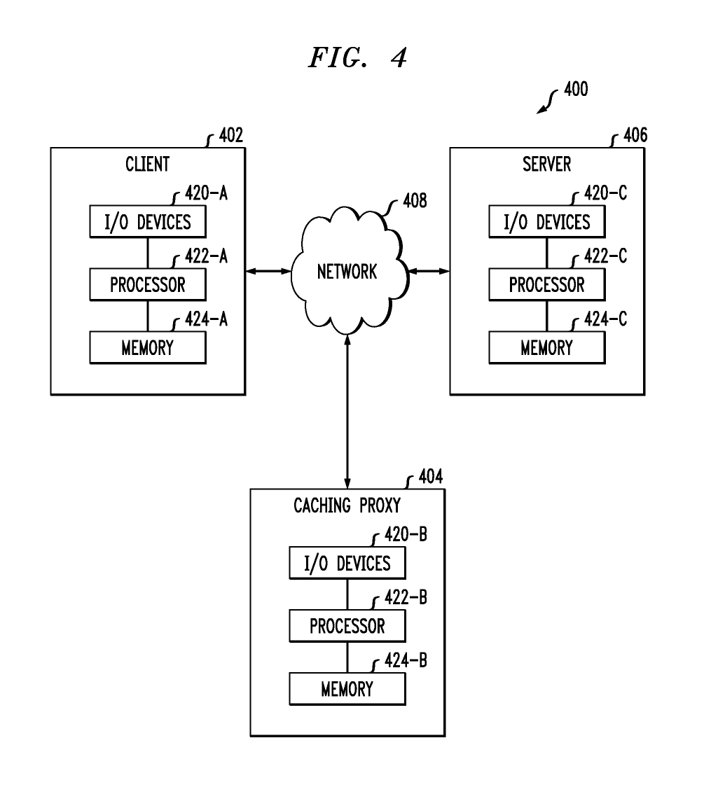

FIG. 4 illustrates a processing architecture 400 for devices used to implement a streaming content system and methodology, according to an embodiment of the invention. It is to be understood that although FIG. 4 shows only a single client 402, caching proxy 404 and server 406, embodiments of the invention may include various other arrangements containing a number of each of such devices. Client 402 may be an HAS client, server 406 may be an HAS server, and caching proxy 404 may be a caching proxy or another network element.

As shown, client device 402, caching proxy 404, and server 406 are coupled via a network 408. The network may be any network across which the devices are able to communicate, for example, as in the embodiments described above, the network 406 could include a publicly-accessible wide area communication network such as a cellular communication network and/or the Internet and/or a private intranet. However, embodiments of the invention are not limited to any particular type of network. Note that when the computing device is a content provider, it could be considered a server, and when the computing device is a content consumer, it could be considered a client. Nonetheless, the methodologies of the present invention are not limited to cases where the devices are clients and/or servers, but instead are applicable to any computing (processing) devices.

As would be readily apparent to one of ordinary skill in the art, the computing devices may be implemented as programmed computers operating under control of computer program code. The computer program code would be stored in a computer readable storage medium (e.g., a memory) and the code would be executed by a processor of the computer. Given this disclosure of the invention, one skilled in the art could readily produce appropriate computer program code in order to implement the methodologies described herein.

As shown, client 402 comprises I/O devices 420-A, processor 422-A and memory 424-A. Caching proxy 404 comprises I/O devices 420-B, processor 422-B and memory 424-B. Server 406 comprises I/O devices 420-C, processor 422-C and memory 424-C.

It should be understood that the term “processor” as used herein is intended to include one or more processing devices, including a central processing unit (CPU) or other processing circuitry, including but not limited to one or more video signal processors, one or more integrated circuits, and the like.

Also, the term “memory” as used herein is intended to include memory associated with a video signal processor or CPU, such as RAM, ROM, a fixed memory device (e.g., hard drive), or a removable memory device (e.g., diskette or CDROM). Also, memory is one example of a computer readable storage medium.

In addition, the term “I/O devices” as used herein is intended to include one or more input devices (e.g., keyboard, mouse) for inputting data to the processing unit, as well as one or more output devices (e.g., a display) for providing results associated with the processing unit.

Accordingly, software instructions or code for performing the methodologies of the invention, described herein, may be stored in one or more of the associated memory devices, e.g., ROM, fixed or removable memory, and, when ready to be utilized, loaded into RAM and executed by the CPU.

Advantageously, embodiments of the invention as illustratively described herein allow for efficient caching in a content streaming system. Embodiments of the invention reduce delays in response to chunk requests by pre-fetching and loading likely next chunks in advance of a request for the next chunk.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method, comprising:
receiving a first request for a first segment of a content stream in a network element from a given one of a plurality of clients;
determining, in the network element, whether the first segment is stored in a memory of the network element;
responsive to the determining step, sending a second request for the first segment from the network element to a server;
responsive to the second request, receiving a response comprising the first segment in the network element from the server; and
sending the first segment from the network element to the given one of the plurality of clients;
wherein the first segment is related to a second segment of the content stream, the relationship between the first segment and the second segment being transparent to the network element but being inferable based at least in part on at least one of the first request, the response and one or more prior requests.

2. The method of claim 1, wherein the second segment is specified in the first request.

3. The method of claim 1, wherein the second segment is identified by at least one of the server and the network element based at least in part on the one or more prior requests.

4. The method of claim 1, further comprising:
determining whether the second segment is stored in the memory of the network element;
responsive to the determining step, sending a third request from the network element to the server for the second segment; and
responsive to the third request, receiving the second segment in the network element from the server.

5. The method of claim 1, wherein the second segment comprises a range of segments of the content stream.

6. The method of claim 5, wherein at least one of the network element and the server identifies the second segment based at least in part on one or more prior requests for one or more segments in the range of segments.

7. The method of claim 1, wherein the second segment comprises a number of subsequent segments of the content stream and wherein the number is a function of at least one of a buffering status of the given one of the plurality of clients, a history of the buffering status of the given one of the plurality of clients, and a fluctuation in a bandwidth of the given one of the plurality of clients over a period of time.

8. The method of claim 1, wherein the first segment is associated with a given one of a plurality of quality levels and a quality level of the second segment is determined based at least in part on the given one of the plurality of quality levels associated with the first segment.

9. The method of claim 1, wherein the content stream is a video stream, and the first and second segments are respective first and second chunks of the video stream.

10. The method of claim 1, wherein the second segment comprises a list of segments, each one of the list of segments being assigned a probability based at least in part on the first segment.

11. The method of claim 1, wherein the given one of the plurality of clients is a Hypertext Transfer Protocol (HTTP) Adaptive Streaming (HAS) client, the server is an HAS server, the network element is a caching proxy, and the first request, second request and response are HTTP commands.

12. The method of claim 11, wherein the second segment is identified in a HAS-specific HTTP header of the first request.

13. The method of claim 11, wherein the content stream is a web page, the first and second segments are respective first and second objects of the web page, and the second segment is identified by a HTTP link header of the first request.

14. A network element, comprising:
a memory; and
a processor coupled to the memory and operative to;
receive a first request for a first segment of a content stream from a given one of a plurality of clients;
determine whether the first segment is stored in the memory;
responsive to the determination, send a second request for the first segment to a server;
responsive to the second request, receive a response comprising the first segment from the server; and
send the first segment to the given one of the plurality of clients;
wherein the first segment is related to a second segment of the content stream, the relationship between the first segment and the second segment being transparent to the network element but being inferable based at least in part on at least one of the first request, the response and one or more prior requests.

15. The network element of claim 14, wherein the processor is further operative to:
determine whether the second segment is stored in the memory;
responsive to the determination, send a third request to the server for the second segment; and
responsive to the third request, receive the second segment from the server.

16. The network element of claim 15, wherein the memory further comprises a flash memory and a hard disk storage, the flash memory having a faster access rate than the hard disk storage, and wherein the processor is further operative to at least one of: move the second segment from the hard disk storage to the flash memory and store the second segment in the flash memory responsive to receiving the first request.

17. The network element of claim 15, wherein the given one of the plurality of clients is a Hypertext Transfer Protocol (HTTP) Adaptive Streaming (HAS) client, the server is an HAS server, the network element is a caching proxy, and the first request, the second request and the response are HTTP commands.

18. A system comprising:
a plurality of clients, at least one network element comprising a memory, and at least one server,
a given one of the plurality of clients being configured to: send a first request for a first segment of a content stream to the at least one network element; and receive the first segment from the at least one network element;
the at least one network element being configured to: receive the first request; determine if the first segment is stored in the memory; responsive to the determination, send a second request for the first segment to the at least one server; responsive to the second request, receive a response comprising the first segment from the at least one server; and send the first segment to the given one of the plurality of clients; and
the at least one server being configured to: receive the second request from the at least one network element; and send the first segment to the at least one network element;
wherein the first segment is related to a second segment of the content stream, the relationship between the first segment and the second segment being transparent to the network element but being inferable based at least in part on at least one of the first request, the response and one or more prior requests.

19. The system of claim 18, wherein the processor is further operative to:
determine whether the second segment is stored in the memory;
responsive to the determination, send a third request to the server for the second segment; and
responsive to the third request, receive the second segment from the server.

20. The system of claim 19, wherein the given one of the plurality of clients is a Hypertext Transfer Protocol (HTTP) Adaptive Streaming (HAS) client, the server is an HAS server, the network element is a caching proxy, and the first request, second request and response are HTTP commands.
